(19) United States
(12) Patent Application Publication
(10) Pub. No.: US 2011/0205967 A1
(43) Pub. Date: Aug. 25, 2011

(54) METHOD FOR SYNCHRONOUSLY MAINTAINING PDP CONTEXT STATUS BETWEEN WIRELESS COMMUNICATION NETWORK AND MOBILE STATION AND ASSOCIATED MOBILE STATION

(76) Inventor: Shan-Wei PING, Taoyuan City (TW)

(21) Appl. No.: 13/030,588

(22) Filed: Feb. 18, 2011

(30) Foreign Application Priority Data
Feb. 23, 2010 (TW) 099105160

(51) Int. Cl. H04W 4/00

(52) U.S. Cl. 370/328

(57) ABSTRACT

A method for synchronously maintaining packet data protocol (PDP) context status between a wireless communication network and a mobile station and an associated mobile station are disclosed to prevent from the asynchronous PDP context status caused by the prior arts. When both the mobile station and the network activate a PDP context for a packet-switched service, if the mobile station is to establish a circuit-switched connection with the network, the mobile station will request the network to suspend the packet-switched service. After the circuit-switched connection is established, the mobile station locally deactivates the PDP context. After the circuit-switched connection is disconnected, if the network informs the mobile station that the packet-switched service is resumed, the mobile station will inform the network that the PDP context is deactivated.

### BACKGROUND OF INVENTION

1. Field of the Invention

The present invention relates to mobile stations in wireless communication networks, and more particularly to a method for synchronously maintaining PDP context status between the wireless communication network and the mobile station and an associated mobile station.

2. Description of the Prior Art

In a GPRS-supported GSM network (called GSM/GPRS network below), when at least one of the network and the mobile station (also called user equipment) does not support dual transfer mode (DTM), the mobile station will not be able to maintain a circuit-switched connection and a packet-switched connection with the network simultaneously. In the GSM/GPRS network, the circuit-switched connection such as a GSM call connection can provide phone call service, while the packet-switched connection such as a GPRS connection can provide data transmission service. Thus, when the DTM is not supported, the mobile station cannot establish the GPRS connection after the GSM call connection with the network is established. This will cause the asynchronous packet data protocol (PDP) context status between the network and the mobile station in some situations.

FIG. 1 shows how the asynchronous PDP context status occurs between the mobile station and the GSM/GPRS network in the prior arts. In the flow of FIG. 1, at the beginning, the mobile station (shown as MS) has already an activated PDP context used for the packet-switched service (i.e. GPRS service in the GSM/GPRS network). Next, in step 11, if the user wants to make a GSM call, the mobile station will on one hand execute the GPRS suspension procedure (cf. 3GPP TS 44.018, section 3.4.25) to request the network to suspend the packet-switched service, and on the other hand execute the call connection procedure to establish the GSM call connection with the network. After the GSM call connection is established, in step 12, if the user no longer wants to use the packet-switched service and thus needs to deactivate the PDP context, then the mobile station will execute the PDP context deactivation procedure (cf. 3GPP TS 24.008, section 6.1.3.4) to send out a Deactivate PDP Context Request message, and start the timer T3390 to wait for the response of the network. However, since the GSM call connection is established, the mobile station cannot establish the GPRS connection so as to transmit the Deactivate PDP Context Request message to the network. Thus, the mobile station will not receive the response from the network until the timer is timeout. Then, according to 3GPP TS 24.008, section 6.1.3.4.3, the mobile station will re-send the Deactivate PDP Context Request message, reset the timer T3390 and wait for the response of the network again. The above process will be performed repeatedly if the mobile station does not receive any response. After the timer T3390 has expired for the fifth time, the mobile station will deactivate the PDP context locally so as to release the related wireless resources and delete the associated information about the PDP context. To “deactivate locally” means that the mobile station only executes the deactivation of the PDP context one-sidedly, without connecting to the network to synchronously complete the PDP context deactivation procedure therewith. So, the network does not know the mobile station has already deactivated the PDP context. Next, in step 13, when the user is to end the GSM call, the mobile station executes the call disconnection procedure; in step 14, the network performs GPRS resumption, and indicates whether the resumption is successful in the RR Channel Release message sent to the mobile station subsequently. If the GPRS resumption is successful, the mobile station determines that there is no need to perform the GPRS resumption and thus the routing area updating procedure will not be executed (cf. 3GPP TS 24.008, section 4.7.5.1). This will cause the problem as below: the PDP context in the side of mobile station is deactivated while the PDP context in the network side is still in activated status, such that the PDP context status between the mobile station and the network is not synchronous. Later, if the mobile station requests to establish a GPRS connection, the network will possibly neglect this request so that the mobile station cannot use the GPRS service.

### SUMMARY OF INVENTION

It is therefore one objective of the present invention to provide a method for synchronously maintaining PDP context status between the wireless communication network and the mobile station and an associated mobile station, thereby preventing from the asynchronous PDP context status between the network and the mobile station caused by the prior arts.

In one embodiment of the present invention, a method used in a mobile station for synchronously maintaining PDP context status between a wireless communication network and the mobile station is provided. Both the mobile station and the wireless communication network activate a PDP context for a packet-switched service. The method comprises: requesting the wireless communication network to suspend the packet-switched service when a circuit-switched connection with the wireless communication network is established; deactivating the PDP context after the circuit-switched connection is established; and informing the wireless communication network, after the circuit-switched connection is disconnected, that the PDP context is deactivated when the wireless communication network informs that the first packet-switched service is resumed.

In another embodiment of the present invention, a mobile station for synchronously maintaining PDP context status with a wireless communication network is provided. Both the mobile station and the wireless communication network activate a PDP context for a packet-switched service. The mobile station comprises: a requesting means for requesting the wireless communication network to suspend the packet-switched service when the mobile station establishes a circuit-switched connection with the wireless communication network; a deactivating means for deactivating the PDP context after the circuit-switched connection is established; and an informing means for informing the wireless communication network, after the circuit-switched connection is disconnected, that the PDP context is deactivated when the wireless communication network informs the mobile station that the first packet-switched service is resumed.

### BRIEF DESCRIPTION OF THE DRAWINGS

FIG. 1 shows how the asynchronous PDP context status occurs between the mobile station and the GSM/GPRS network in the prior arts.

FIG. 2 shows how the problem of the asynchronous PDP context status between the mobile station and the GSM/GPRS network is handled according to one embodiment of the present invention.

FIG. 3 is a flow chart of the method for synchronously maintaining the PDP context status between the wireless communication network and the mobile station according to one embodiment of the present invention.

FIG. 4 shows part of the data format of the Routing Area Update Request message.

FIG. 5 shows the format of the information element of the PDP context status.

FIG. 6 shows a block diagram of one embodiment of the mobile station according to the present invention.

### DETAILED DESCRIPTION

Reference will now to be made in detail to embodiments of the present invention, which are illustrated in the accompanying drawings. All the embodiments can be applied to the case where at least one of the mobile station (for example, but not limited to, the mobile phone) and the wireless communication network (for example, but not limited to, the GSM/GPRS network) does not support the DTM. When the wireless communication network does not support the DTM, it does not necessarily mean that the whole network does not support. Instead, it is possible that only part of the network equipments such as cells does not support while the others do. Thus, when the mobile station connects to the network via the network equipment not supporting the DTM, the present invention can still apply to.

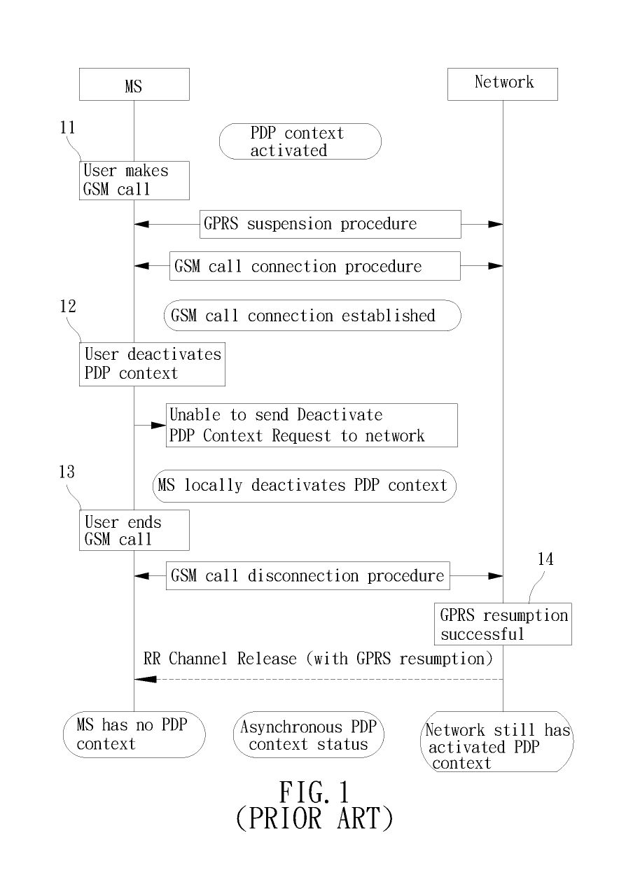

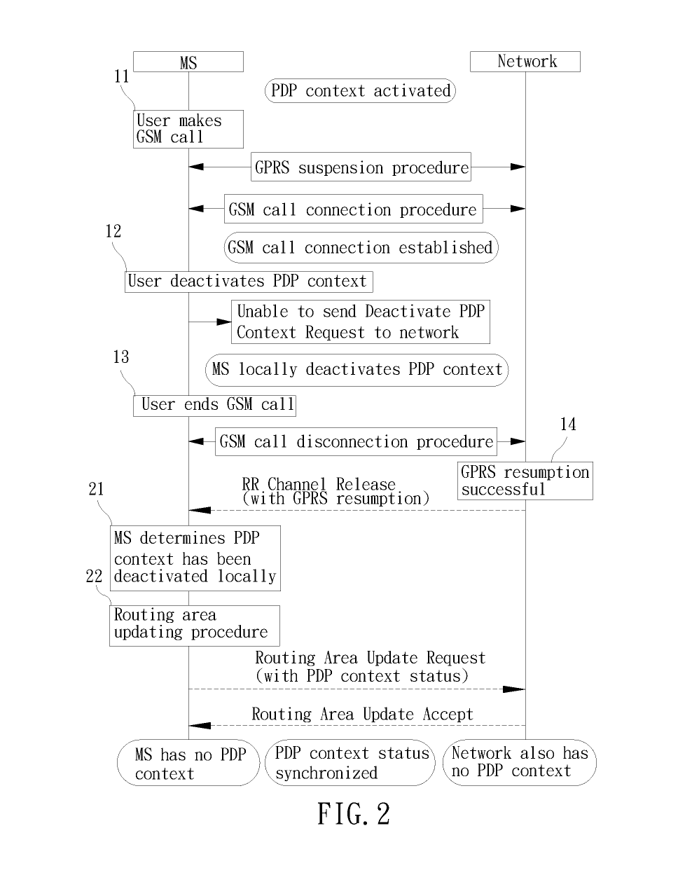

In the GSM/GPRS network, if the mobile station supports GPRS function, the routing area updating procedure is periodically executed to inform the network of the current routing area where the mobile station is located. In other specific situations, e.g. when the mobile station determines that the GPRS resumption needs to be performed, it will also execute the routing area updating procedure, as described in 3GPP TS 24.008, section 4.7.5.1. However, in step 14 of FIG. 1, if the network successfully performs the GPRS resumption and informs the mobile station about that after the GSM call is over, the mobile station will determine that there is no need to perform the GPRS resumption. Thus, the mobile station will not also execute the routing area updating procedure so that the asynchronous PDP context status exists between the mobile station and the network. Therefore, in one embodiment of the present invention, a new specific situation where the mobile station needs to execute the routing area updating procedure is added, that is, if the mobile station has locally deactivated the PDP context previously, then the mobile station also needs to execute the routing area updating procedure, as shown in steps 21 and 22 of FIG. 2. In step 21, the mobile station (shown as MS) determines that the PDP context has been locally deactivated previously, and then in step 22, the mobile station executes the routing area updating procedure to send out the Routing Area Update Request message to the network. The Routing Area Update Request message includes an information element showing the current PDP context status (i.e. deactivated at this situation) in the mobile station. Thus, after the network responds the Routing Area Update Accept message to the mobile station, the synchronous PDP context status can be reached between the mobile station and the network, as shown in FIG. 2.

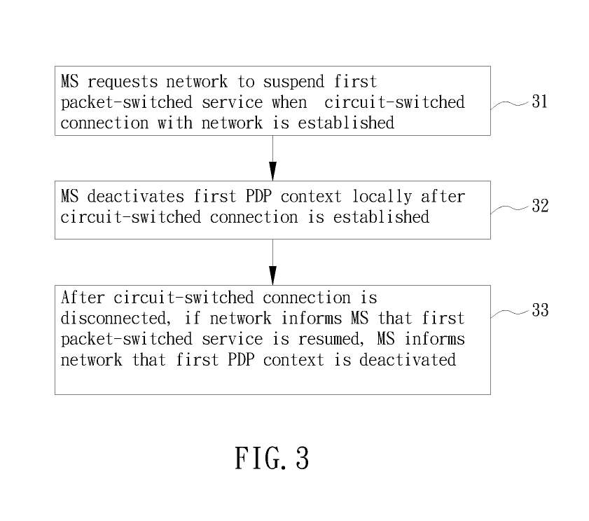

FIG. 3 is a flow chart of the method for synchronously maintaining the PDP context status between the wireless communication network and the mobile station according to one embodiment of the present invention. This method is used in the mobile station. Before executing the method, both the mobile station and the wireless communication network activate a first PDP context for a first packet-switched service. In step 31, when establishing a circuit-switched connection (e.g. phone call connection) with the network, the mobile station (shown as MS in FIG. 3) requests the network to suspend the first packet-switched service. When the network is a GSM/GPRS network, the circuit-switched connection can be a GSM call connection, and the mobile station can execute the GPRS suspension procedure (cf. 3GPP TS 44.018, section 3.4.25) to request the GSM/GPRS network to suspend the first packet-switched service.

In step 32, after the circuit-switched connection is established, the mobile station deactivates the first PDP context locally. The mobile station can perform this deactivation according to an internal configuration or a request of the user. When the network is the GSM/GPRS network, the mobile station will execute the PDP context deactivation procedure (cf. 3GPP TS 24.008, section 6.1.3.4). If the mobile station sends out the Deactivate PDP Context Request message five times while still receives no response from the network within the timeout of the timer T3390, then the mobile station deactivates the first PDP context locally.

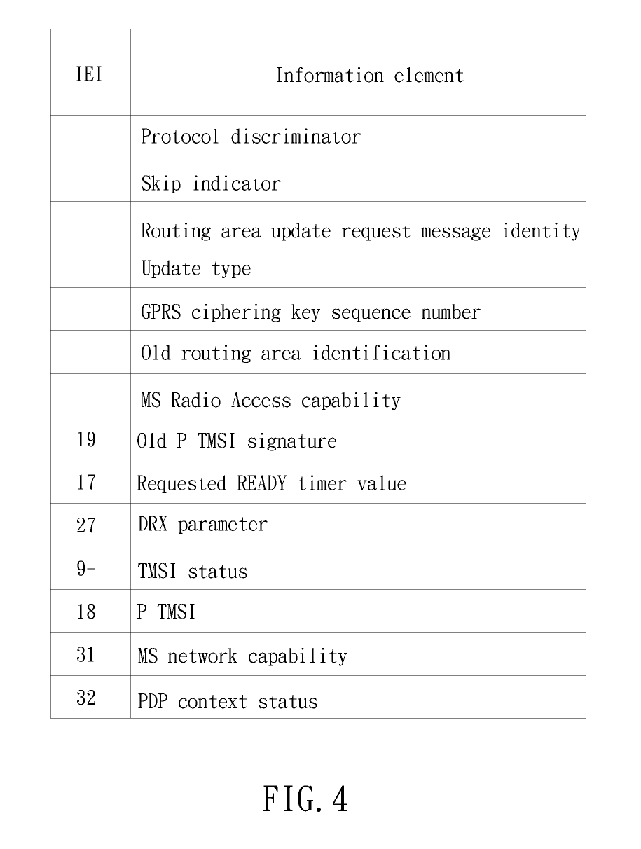

In step 33, after the circuit-switched connection is disconnected, if the network informs the mobile station that the first packet-switched service is resumed, then the mobile station informs the network about the deactivated status of the first PDP context so as to synchronize the PDP context status between the mobile station and the network. When the network is the GSM/GPRS network, the mobile station can inform the network about the deactivated status of the first PDP context by executing the routing area updating procedure to send out the Routing Area Update Request message, whose data format is partly shown in FIG. 4 (also cf. 3GPP TS 24.008, table 9.4.14). The information element of the PDP context status, whose information element identifier (IEI) is 32, can be used to record the current status of the first PDP context. Thus, when receiving the Routing Area Update Request message, the network can update the status of the first PDP context according to the information element of the PDP context therein, thereby keeping synchronized with the mobile station.

Preferably, in step 32, the mobile station further stores a deactivation record for showing that the mobile station has deactivated the first PDP context locally. Then, in step 33, the mobile station informs the network about the deactivated status of the first PDP context according to the deactivation record.

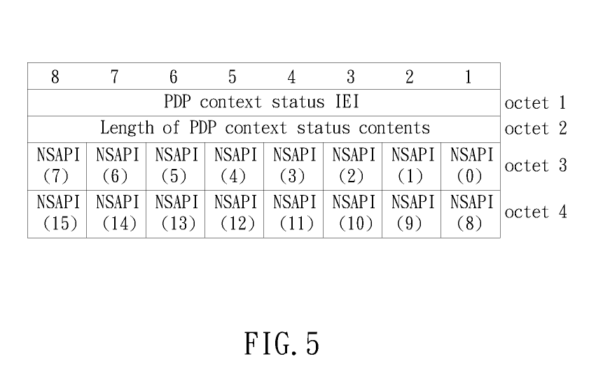

The embodiment of FIG. 3 can be extended to the case where two or more PDP contexts have been activated between the mobile station and the network. An embodiment including two activated PDP contexts are described below: in addition to the first PDP context, both the mobile station and the network have further activated a second PDP context for a second packet-switched service. In this embodiment, each step of FIG. 3 is adjusted as follows: in step 31, when the circuit-switched connection is established, the mobile station requests the network to suspend both the first and second packet-switched services; in step 32, after the circuit-switched connection is established, the mobile station locally deactivates the first and second PDP contexts; in step 33, after the circuit-switched connection is disconnected, if the network informs the mobile station that the first and second packet-switched services are resumed, then the mobile station informs the network that the first and second PDP contexts are deactivated. When the network is the GSM/GPRS network, the mobile station can inform the network about the deactivated status of the first and second PDP contexts by executing the routing area updating procedure only once. This is because the information element of the PDP context in the Routing Area Update Request message can record the current status of multiple PDP contexts simultaneously, as shown in FIG. 5 (cf. 3GPP TS 24.008, table 10.5.148). Each NSAPI (i.e. network service access point identifier) is one bit value for representing the status of one PDP context, wherein 0 and 1 represent deactivated and activated respectfully. However, it should be noted that NSAPI(0)˜NSAPI(4) are reserved for other use in the current 3GPP specification. Since the informing of the deactivated status of both the first and second PDP contexts only needs one-time execution of the routing area updating procedure, the signaling load between the mobile station and the network can be reduced. Regarding the case where three or more PDP contexts have been activated, the method for synchronously maintaining the PDP context status between the mobile station and the network can be derived similarly as above.

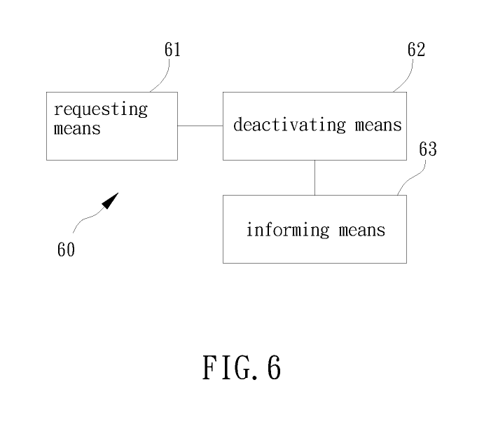

FIG. 6 shows a block diagram of one embodiment of the mobile station 60 according to the present invention. The mobile station 60 is capable of synchronously maintaining the PDP context status with the wireless communication network, and comprises a requesting means 61, a deactivating means 62 and an informing means 63. In this embodiment, both the mobile station 60 and the wireless communication network activate the first PDP context for the first packet-switched service. The requesting means 61 requests the network to suspend the first packet-switched service when the mobile station 60 establishes a circuit-switched connection with the network. The deactivating means 62 locally deactivates the first PDP context after the circuit-switched connection is established. After the circuit-switched connection is disconnected, if the network informs the mobile station 60 that the first packet-switched service is resumed, then the informing means 63 informs the network that the first PDP context is deactivated. When the network is a GSM/GPRS network, the informing means 63 can inform the network about the deactivated status of the first PDP context by executing the routing area updating procedure to send out the Routing Area Update Request message.

Preferably, the deactivating means 62 further stores a deactivation record in the mobile station 60 for showing that the mobile station 60 has deactivated the first PDP context locally. The informing means 63 then informs the network about the deactivated status of the first PDP context according to the deactivation record.

If both the mobile station 60 and the network activate the first PDP context for the first packet-switched service and a second PDP context for a second packet-switched service, then the requesting means 61 requests the network to suspend both the first and second packet-switched services when the above circuit-switched connection is established. Then, after the circuit-switched connection is established, the deactivating means 62 locally deactivates the first and second PDP contexts. After the circuit-switched connection is disconnected, if the network informs the mobile station 60 that the first and second packet-switched services are resumed, then the informing means 63 informs the network that the first and second PDP contexts are deactivated. When the network is the GSM/GPRS network, the informing means 63 can inform the network about the deactivated status of the first and second PDP contexts by executing the routing area updating procedure only once, as explained above.

Please note that all of the requesting means 61, the deactivating means 62 and the informing means 63 mentioned above can be realized by hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (SIP), or computer on module (COM).

While the present invention has been shown and described with reference to the preferred embodiments thereof and the illustrative drawings, it should not be considered as limited thereby. Various possible modifications and alterations can be conceived by persons skilled without departing from the scope and the spirit of the present invention.

What is claimed is:

1. A method used in a mobile station for synchronously maintaining packet data protocol (PDP) context status between a wireless communication network and the mobile station, wherein both the mobile station and the wireless communication network activate a first PDP context for a first packet-switched service, the method comprising:
requesting the wireless communication network to suspend the first packet-switched service when a circuit-switched connection with the wireless communication network is established;
deactivating the first PDP context after the circuit-switched connection is established; and
informing the wireless communication network, after the circuit-switched connection is disconnected, that the first PDP context is deactivated when the wireless communication network informs that the first packet-switched service is resumed.

2. The method of claim 1, wherein the deactivating step is executed according to request of a user.

3. The method of claim 1, wherein the deactivating step comprises:
storing a deactivation record for showing that the mobile station has deactivated the first PDP context.

4. The method of claim 3, wherein the informing step is executed according to the deactivation record.

5. The method of claim 1, wherein the wireless communication network is a GPRS-enabled GSM network.

6. The method of claim 5, wherein the informing step is executed by executing a routing area updating procedure.

7. The method of claim 6, wherein the routing area updating procedure comprises sending a Routing Area Update Request message to the wireless communication network, wherein the Routing Area Update Request message comprises an information element indicating a status of the first PDP context.

8. The method of claim 1, wherein both the mobile station and the wireless communication network further activate a second PDP context for a second packet-switched service, the method further comprising:
requesting the wireless communication network to suspend the second packet-switched service when the circuit-switched connection is established;
deactivating the second PDP context after the circuit-switched connection is established; and
informing the wireless communication network, after the circuit-switched connection is disconnected, that the second PDP context is deactivated when the wireless communication network informs that the second packet-switched service is resumed.

9. A mobile station for synchronously maintaining packet data protocol (PDP) context status with a wireless communication network, wherein both the mobile station and the wireless communication network activate a first PDP context for a first packet-switched service, the mobile station comprising:
a requesting means for requesting the wireless communication network to suspend the first packet-switched service when the mobile station establishes a circuit-switched connection with the wireless communication network;
a deactivating means for deactivating the first PDP context after the circuit-switched connection is established; and
an informing means for informing the wireless communication network, after the circuit-switched connection is disconnected, that the first PDP context is deactivated when the wireless communication network informs the mobile station that the first packet-switched service is resumed.

10. The mobile station of claim 9, wherein the deactivating means deactivates the first PDP context according to request of a user.

11. The mobile station of claim 9, wherein the deactivating means further stores a deactivation record for showing that the mobile station has deactivated the first PDP context.

12. The mobile station of claim 11, wherein the informing means informs the wireless communication network according to the deactivation record.

13. The mobile station of claim 9, wherein the wireless communication network is a GPRS-enabled GSM network.

14. The mobile station of claim 13, wherein the informing means informs the wireless communication network by performing a routing area updating procedure.

15. The mobile station of claim 14, wherein the routing area updating procedure comprises sending a Routing Area Update Request message to the wireless communication network, wherein the Routing Area Update Request message comprises an information element indicating a status of the first PDP context.

16. The mobile station of claim 9, wherein both the mobile station and the wireless communication network further activate a second PDP context for a second packet-switched service; the requesting means further requests the wireless communication network to suspend the second packet-switched service when the circuit-switched connection is established; the deactivating means further deactivates the second PDP context after the circuit-switched connection is established; the informing means further informs the wireless communication network, after the circuit-switched connection is disconnected, that the second PDP context is deactivated when the wireless communication network informs the mobile station that the second packet-switched service is resumed.
